(19) United States
(12) Patent Application Publication
(10) Pub. No.: US 2022/0134800 A1
(43) Pub. Date: May 5, 2022

(54) STACKABLE MAGNETIZED PAINT BUCKET

(71) Applicant: Rafael Alvarez, Aurora, IL (US)

(72) Inventor: Rafael Alvarez, Aurora, IL (US)

(21) Appl. No.: 17/518,194

(22) Filed: Nov. 3, 2021

Related U.S. Application Data
(60) Provisional application No. 63/109,427, filed on Nov. 4, 2020.

(51) Int. Cl. B44D 3/14

(52) U.S. Cl. CPC B44D 3/14; B44D 3/123

(57) ABSTRACT

A stackable magnetized bucket with integral handle and grate comprises a generally cylindrical container that has a rounded sidewall. The sidewall extends upwardly from a floor wall to a rim that forms an open top. A portion of the sidewall forms a flat side that is sloped inwardly from the rim to the floor wall to enable stacking multiple containers. A grate that rests on the inner surface of the flat side to enable scraping paint from a paint brush or roller. The grate can have multiple textured configurations and openings that enhance the squeezing of paint. The container also comprises an integrated handle that forms at a peripheral flange beneath the rim. The integrated handle is sized to enable gripping the top end of the container. A magnet that positions proximal to the rim, on the outer surface of the sidewall to detachably attach with a magnetized mounting surface.

### CROSS REFERENCE TO RELATED APPLICATIONS

The present disclosure claims priority to U.S. Provisional Pat. App. No. 63/109,427, filed on Nov. 4, 2020, and which is hereby incorporated by reference in its entirety.

### FIELD OF THE DISCLOSURE

The present disclosure relates generally to a stackable magnetized paint bucket with integral handle and grate. More so, a cylindrical container, such as a 2-gallon paint bucket, has a rounded sidewall extending upwardly from a floor wall to a rim that forms an open top, with a portion of the sidewall forming a flat side that is sloped inwardly from rim to floor wall to enable stacking multiple containers, and a grate that rests on the inner surface of the flat side for scraping a liquid from a liquid applicator; and further includes an integrated handle forming at a peripheral flange beneath the rim for gripping the container; and further includes a magnet for mounting the container to a corresponding magnetized mount.

### BRIEF DESCRIPTION OF THE DRAWINGS

The disclosure will now be described, by way of example, with reference to the accompanying drawings, in which:

FIG. 1 illustrates a perspective view of an exemplary stackable magnetized bucket with integral handle and grate, in accordance with an embodiment of the present disclosure;

FIG. 2 illustrates a perspective view of the inside of the bucket, showing the paint contained therein, and the inner surface of the grate, in accordance with an embodiment of the present disclosure;

FIG. 3 illustrates a perspective view of the outside of the bucket, showing the grate, in accordance with an embodiment of the present disclosure;

FIG. 4 illustrates a perspective view of the bucket, showing a hand gripping the container at the convex handle, in accordance with an embodiment of the present disclosure;

FIG. 5 illustrates a perspective view of the bucket, showing a hand lifting the container at the convex handle, in accordance with an embodiment of the present disclosure;

FIG. 6 illustrates a perspective view of the inside of the bucket, showing the magnet and the convex handle, in accordance with an embodiment of the present disclosure; and

FIG. 7 illustrates a perspective view of an embodiment of the stackable magnetized bucket, showing the bucket without certain features present.

Like reference numerals refer to like parts throughout the various views of the drawings.

### DETAILED DESCRIPTION OF THE DISCLOSURE

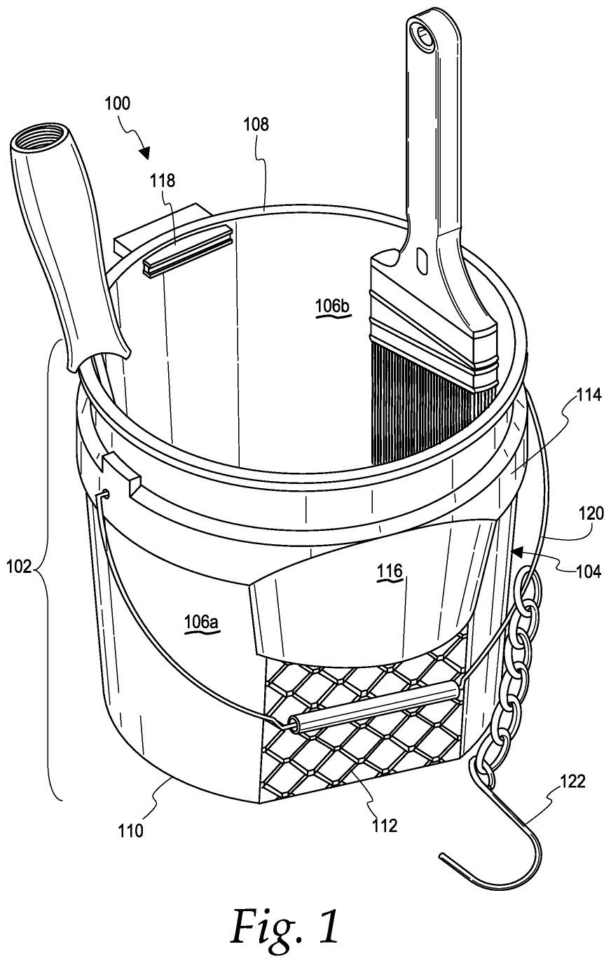

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper,” “lower,” “left,” “rear,” “right,” “front,” “vertical,” “horizontal,” and derivatives thereof shall relate to the disclosed bucket as oriented in FIG. 1. Furthermore, there is no intention to be bound by any expressed or implied theory presented in the preceding technical field, brief summary or the following detailed description. It is also to be understood that the specific devices and processes illustrated in the attached drawings, and described in the following specification, are simply exemplary embodiments of the concepts defined in the appended claims. Hence, specific dimensions and other physical characteristics relating to the embodiments disclosed herein are not to be considered as limiting, unless the claims expressly state otherwise.

At the outset, it should be clearly understood that like reference numerals are intended to identify the same structural elements, portions, or surfaces consistently throughout the several drawing figures, as may be further described or explained by the entire written specification of which this detailed description is an integral part. The drawings are intended to be read together with the specification and are to be construed as a portion of the entire “written description” of this disclosure as required by 35 U.S.C. § 112.

In one embodiment of the present disclosure presented in FIGS. 1-8, a stackable magnetized bucket 100 with integral handle and grate, hereafter, “bucket 100” provides an improvement on buckets that are configured to carry paint and other commercial grade liquids, through use of multiple novel structural configurations that facilitate paint bucket-related functions, like: stacking multiple paint buckets, carrying paint in the paint bucket, handling the paint bucket, squeezing paint from paint brushes and rollers, hanging paint brushes and rollers from the rim of the paint bucket, and mounting the paint bucket.

In some embodiments, the bucket 100 comprises a generally cylindrical container 102 that has a rounded sidewall 104. The sidewall 104 extends upwardly from a floor wall 110 to a rim 108 that forms an open top. A portion of the sidewall 104 forms a flat side that is sloped inwardly from the rim 108 to the floor wall 110 to enable stacking multiple containers.

In other embodiments, the bucket 100 provides a grate 112 that rests on the inner surface 106b of the flat side. The grate 112 is configured to enable scraping paint, or a commercial liquid from a paint brush or roller. The grate 112 can have multiple textured configurations and openings that enhance the removal of paint from a brush or roller. In one embodiment the grate 112 can utilize a honeycomb pattern as depicted that is advantageous for removing paint from a typical brush.

The container 102 also comprises an integrated handle that forms at a peripheral flange 114 beneath the rim 108. The integrated handle is sized and dimensioned to enable a hand to grip the top end of the container 102. The container 102 also comprises a magnet 118 that positions proximal to the rim 108, on the outer surface 106a of the sidewall 104. The magnet 118 is configured to detachably attach with a magnetized mounting surface, so that the paint inside the container 102 can be accessed without requiring the painter to hold the container 102 simultaneously. With the magnet 118, the container 102 may be mounted to the magnetized mounting structure in an upright position, so as to enable easy paint access and paint squeezing from the paint brush and roller. In addition, the magnet 118 allows for a painter to place the metallic portion of a brush—typically the bristle holder—against the magnet, allowing the painter to keep a hand free without placing the brush directly in the paint, which will typically be in the lower portion of the interior of the container 102.

In one aspect of the present disclosure, a stackable magnetized bucket 100 with integral handle and grate, comprises:
a container 102 defined by a rounded sidewall 104 having an inner surface 106b and an outer surface 106a, the sidewall 104 extending upwardly from a floor wall 110 to a rim 108 that forms an open top,
a portion of the sidewall 104 forming a flat side being configured to slope inwardly from the rim 108 to the floor wall 110,
whereby the sloped flat side enables stacking of multiple buckets;
a grate 112 defined by a texture, the grate 112 disposed on the flat side of the sidewall 104,
whereby the grate 112 enables squeezing paint from a paint brush and a roller;
a peripheral flange 114 disposed in a spaced apart relationship with the rim 108 of the container 102, a portion of the peripheral flange 114 forming a convex handle 116,
whereby the convex handle 116 enables gripping the container 102; and
a magnet 118 disposed proximal to the rim 108, on the outer surface 106a of the sidewall 104,
whereby the magnet 118 enables detachable attachment of the container 102 with a magnetized mounting surface.

In a second aspect, the container 102 is a 2-gallon paint bucket.

In another aspect, the container 102 has a cylindrical shape.

In another aspect, the grate 112 is disposed on the inner surface 106b of the flat side of the sidewall 104.

In another aspect, the peripheral flange 114 orients towards the floor wall 110.

In another aspect, the magnet 118 is elongated.

In another aspect, an exemplary grate 112 has multiple honeycomb-shaped openings 402.

In another aspect, the container 102 comprises a plastic material.

One objective of the present disclosure is to enable easy squeezing and scraping of paint directly from an integrated grate 112 in the paint bucket.

Another objective is to allow multiple paint buckets to be stacked into each other.

Another objective is to allow for easy handling of the paint bucket from a hand-sized convex handle 116 directly under the rim 108.

Yet another objective is to allow a painter to handle the paint bucket 100 with one hand while painting a floorboard.

Those skilled in the art will recognize that a painter uses a paint brush or a roller to apply paint. Typically, the paint is purchased in one-gallon cans or, for larger commercial jobs, two or five-gallon plastic buckets. The painter can apply paint to a surface with a roller either by rolling the roller brush in a shallow tray that has been filled with paint or by dipping it into a bucket. The painter then rolls the roller against a grate or similar flat surface, which may either be integrally formed in a tray bottom or may be a separate screen or grate.

It is also known that when applying paint from a bucket, the painter inserts the grate into the bucket and props it against the wall of the bucket. The upper edge of the grate may have a hook that can be hung over the bucket rim to stabilize it. The painter dips the roller into the paint in the bucket and then rolls it against the grate in the bucket to remove the excess paint and more evenly distribute the paint throughout the roller. However, the grate is not always accessible to the paint bucket. Also, the painter must often use one or two hands to hold the paint bucket while painting. There is not always an effective mounting structure on the paint bucket.

As referenced in FIG. 1, the bucket 100 comprises a container 102 that is configured to contain paint, or a commercial liquid. In some embodiments, the container 102 is defined by a rounded sidewall 104 having an inner surface 106b and an outer surface 106a. The paint engages the inner surface 106b, and can be filled up to the rim 108. The rounded shape of the sidewall 104 forms a generally cylindrical container 102. However, in alternative embodiments, a rectangular or cubicle shape of the container may be used.

In some alternative embodiments, the container 102 is provided in combination with paint or other material suitable for application with a brush or a roller as an integral product. Thus, the painter is only required to open the container 102 to access the paint.

In some embodiments, the container 102 may include a 2-gallon paint bucket. However, in another embodiment, the container 102 may be larger or smaller. Suitable materials for the container 102 may include, without limitation, plastic, a rigid polymer, polyethylene, aluminum, steel, a metal; alloy, and wood.

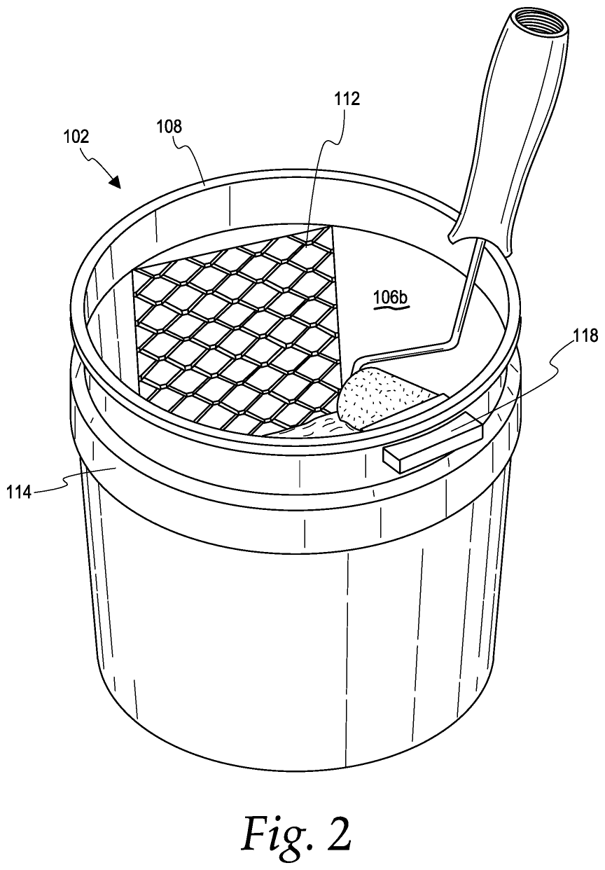

In one possible disposition of the container 102, referenced in FIG. 2, the sidewall 104 extends upwardly from the floor wall 110 to the rim 108. The floor wall 110 may be a circular base panel. The rim 108 forms the terminus and forms an open top. A portion of the sidewall 104 forms a flat side that is configured to slope inwardly from the rim 108 to the floor wall 110. The flat side may be a 3″-12″ wide, such that the container 102 still retains a generally cylindrical shape. The flat side also slopes at a slight angle from the rim 108 to the floor wall 110. In one non-limiting embodiment, the slope is between about 1°-5°. The slope creates a space for an adjacent sloped sidewall 104 to slidably engage the flat side. In this manner, the sloped flat side enables stacking of multiple buckets. In one embodiment, a pivotable bucket handle 120 extends from opposite ends of the rim 108. In other embodiments, a hook chain 122 may attach to the bucket handle 120 to enable hanging the container 102.

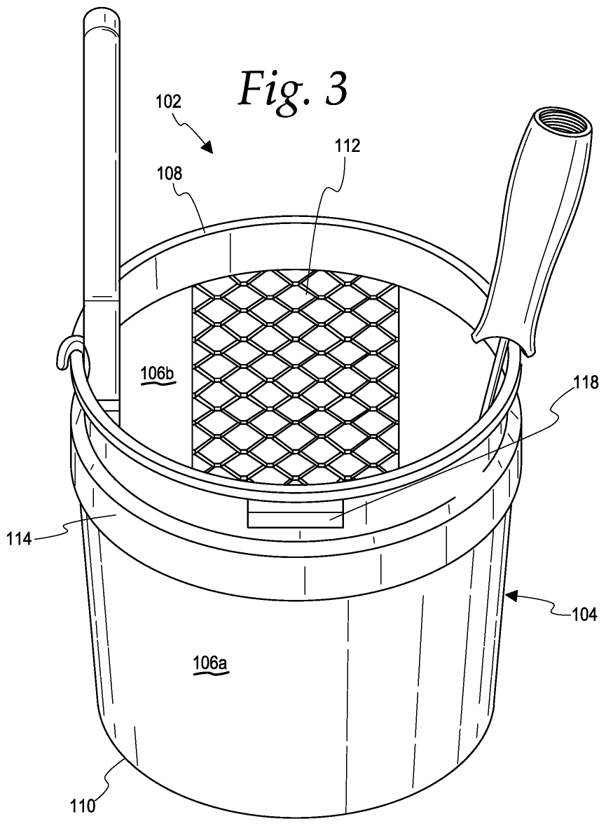

As illustrated in FIG. 3, the bucket 100 also includes a grate 112, or paint screen, that forms a textured surface for squeezing, or scraping, paint from a brush or roller. The textured surface of the grate 112 may consist of elongated protrusions that angle inwardly along the length of the grate 112. The textured surface can also be configured onto a grate 112 having multiple honeycomb-shaped openings as depicted. The openings enable passage of the paint as the brush or roller engages the surface of the grate 112. However, additional textures, patterns, and openings for the grate may be used, so as to optimize scraping of paint from the brush or roller.

In one embodiment, the grate 112 has an elongated rectangular shape that is defined by a width and a length that matches the dimensions of the flat side of the sidewall 104. In this configuration, the grate 112 attaches to or is integrated with the flat side of the sidewall 104, on the inner surface 106b. The attachment or integration of the grate 112 to the inner surface of the container sidewall may be permanent, thereby creating an integrated grate 112. Further, since the grate 112 attaches to the sloped flat side of the sidewall 104, the paint more efficiently rolls down the length of the inner surface 106b of the container 102, as gravity carries the paint towards the floor wall 110. This creates a container 102 with an integrated grate 112 for squeezing paint from a paint brush and a roller.

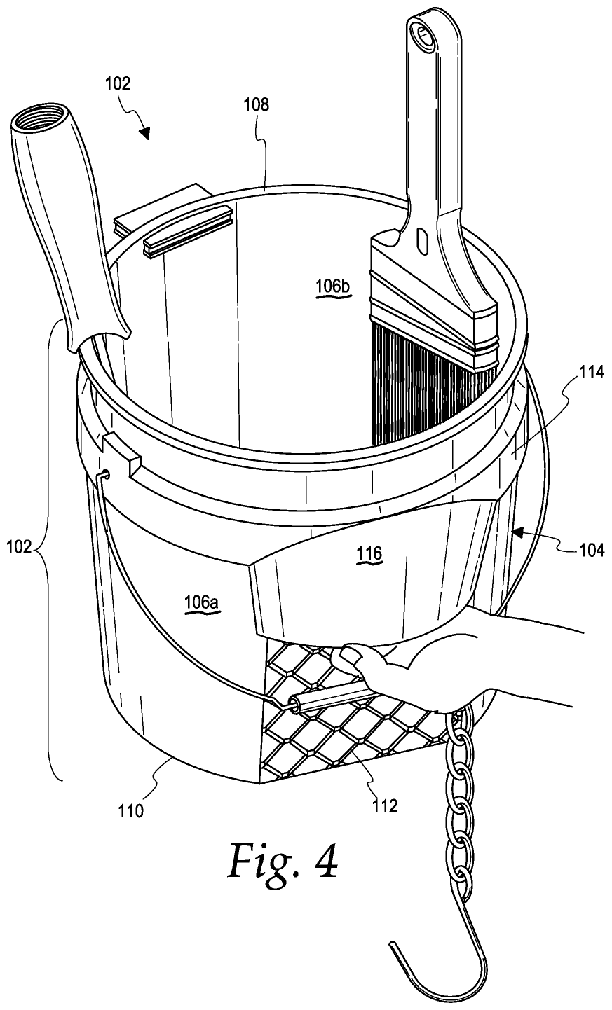

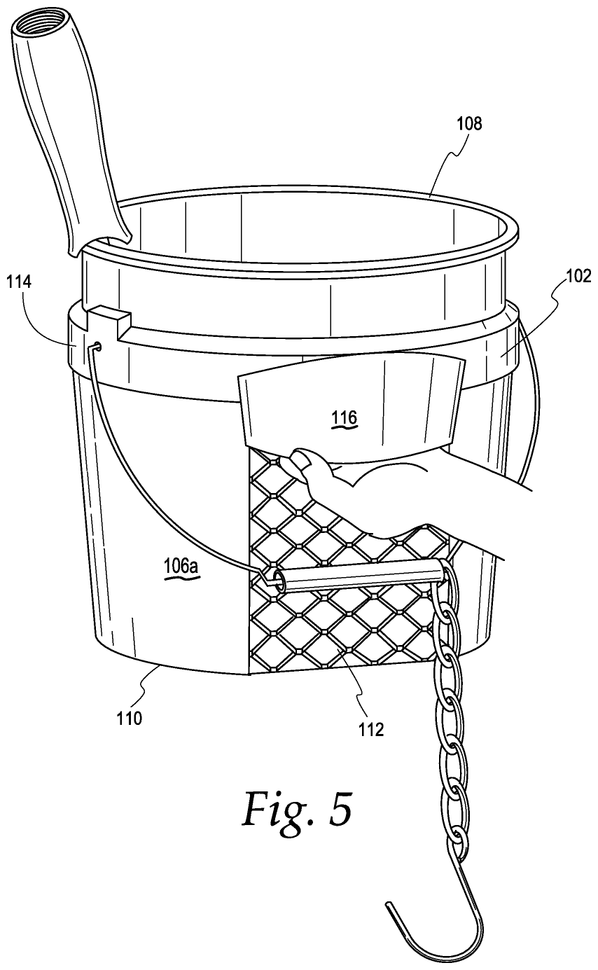

Turning now to FIG. 4, the container 102 is easily gripped and lifted through use of a peripheral flange 114 that forms a hand-sized convex handle 116 that extends across a short section of the peripheral flange 114. The peripheral flange 114 circumambulates the sidewall 104, and is disposed in a spaced apart relationship with the rim 108 of the container 102. The peripheral flange 114 orients towards the floor wall 110, such that a hand can grip the flange 114 while pulling the container 102 upwardly (See FIG. 5). A portion of the peripheral flange 114 forms a convex handle 116 that is sized and dimensioned to receive the four fingers of the hand. This may include a convex handle 116 that is 3″-9″ long. The convex handle 116 bulges outwardly, so that the ends of the fingers and knuckles can fit therein.

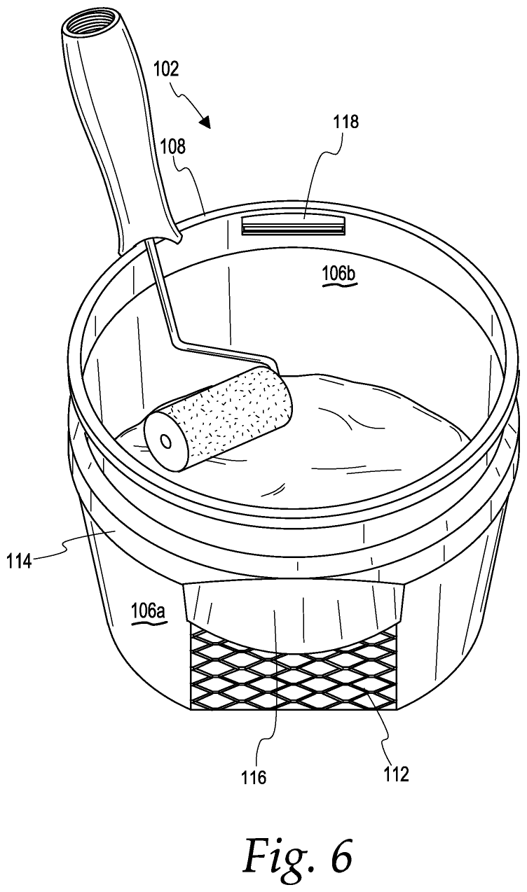

In some embodiments, the container 102 also includes a magnet 118 integrated therein for mounting the container to a magnetized mounting surface. The magnet 118 is disposed proximal to the rim 108, on the outer surface of the sidewall 104. As FIG. 6 illustrates, the magnet 118 is elongated, and spaced a few inches from the rim 108. The magnet 118 is configured to enable detachable attachment of the container 102 with a magnetized mounting surface. In this manner, the painter can easily handle the paint bucket with one hand while painting a floorboard or navigating a ladder.

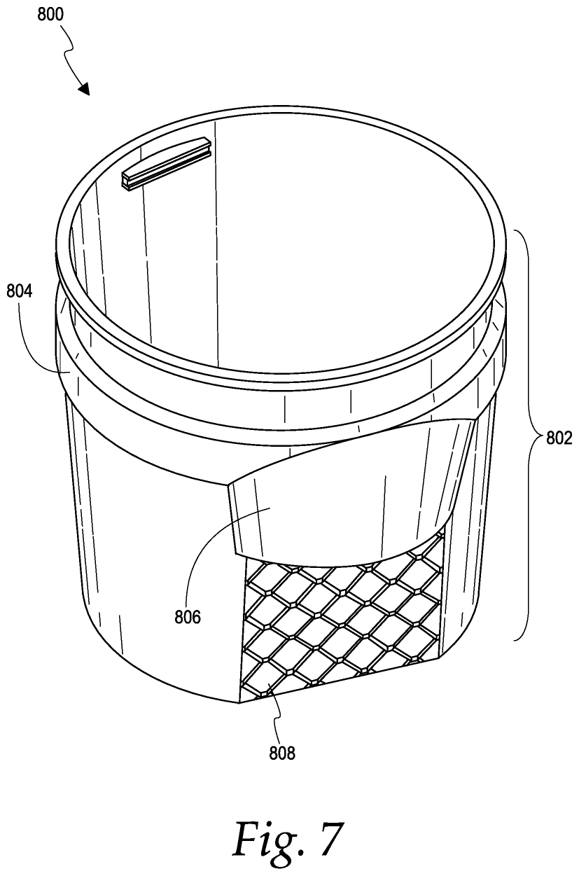

FIG. 7 illustrates a perspective view of an embodiment of the stackable magnetized bucket 800 without certain features present. In this embodiment, the container 802 has a peripheral flange 804 that supports a large convex handle 806. The large convex handle 806 may be about ⅓ of the circumference of the container 802. The bucket 800 comprises a grate 808 that rests on the inner surface of the flat side. The grate 808 is configured to enable scraping paint, or a commercial liquid from a paint brush or roller.

In operation, paint is poured into the container through the open end at the top. The brush or roller is dipped into the paint and excess paint is squeezed or dripped off the grate. The container can be mounted through the magnet to a magnetized surface. The convex handle—either small or large—is used to carry the bucket into operation. Also, the flat side allows multiple buckets to be stacked during stowage.

Since many modifications, variations, and changes in detail can be made to the described preferred embodiments of the disclosure, it is intended that all matters in the foregoing description and shown in the accompanying drawings be interpreted as illustrative and not in a limiting sense. Thus, the scope of the disclosure should be determined by the appended claims and their legal equivalence.

What I claim is:

1. A stackable bucket comprising:
a container defined by a rounded sidewall, the sidewall extending upward from a floor wall to a rim that forms an open top,
a portion of the sidewall forming a flat side configured to slope inwardly from the rim to the floor wall,
whereby the sloped flat side enables stacking of multiple buckets; and
a grate defined by a texture, the grate disposed on an outer surface of the flat side of the sidewall.

2. The stackable bucket of claim 1 further comprising a rounded handle disposed at least partially the flat side.

3. The stackable bucket of claim 2 wherein the rounded handle is a metal handle.

4. The stackable bucket of claim 1 further comprising a magnet disposed on an interior surface of the rounded sidewall near the rim.

5. The stackable bucket of claim 4 wherein the magnet is disposed on the interior surface of the rounded sidewall opposite the flat side.

6. The stackable bucket of claim 2 wherein the container is a 2-gallon paint bucket.

8. A stackable bucket with integral handle and grate, the bucket comprising:
a container defined by a rounded sidewall having an inner surface and an outer surface, the sidewall extending upward from a floor wall to a rim that forms an open top,
a portion of the sidewall forming a flat side configured to slope inwardly from the rim to the floor wall,
whereby the sloped flat side enables stacking of multiple buckets;
a grate defined by a texture, the grate disposed on the flat side of the sidewall,
whereby the grate enables squeezing paint from a paint brush and a roller;
a peripheral flange disposed in a spaced apart relationship with the rim of the container, a portion of the peripheral flange forming a convex handle,
whereby the convex handle enables gripping the container; and
a magnet disposed proximal to the rim, on the inner surface of the rounded sidewall,
whereby the magnet enables detachable attachment of the container with a magnetized mounting surface.

9. The bucket of claim 8 wherein the container is a 2-gallon paint bucket.

10. The bucket of claim 8 wherein the container has a cylindrical shape.

11. The bucket of claim 8 wherein the peripheral flange orients towards the floor wall.

12. The bucket of claim 8 wherein the magnet is elongated.

13. The bucket of claim 8 wherein the grate has multiple honeycomb-shaped openings.

14. The bucket of claim 8 wherein the container comprises a plastic material.
